(19) United States
(12) Patent Application Publication
(10) Pub. No.: US 2011/0238705 A1
(43) Pub. Date: Sep. 29, 2011

(54) SYSTEM, METHOD AND COMPUTER PROGRAM PRODUCT FOR EXTENDING A MASTER-DETAIL RELATIONSHIP

(75) Inventors: Gary John Baker, San Francisco, CA (US); Rob Woollen, San Rafael, CA (US); Sonali Agrawal, San Carlos, CA (US)

(73) Assignee: salesforce.com, inc., San Francisco, CA (US)

(21) Appl. No.: 13/072,600

(22) Filed: Mar. 25, 2011

Related U.S. Application Data
(60) Provisional application No. 61/317,671, filed on Mar. 25, 2010.

(51) Int. Cl. G06F 17/30

(52) U.S. Cl. 707/802; 707/E17.005

(57) ABSTRACT

In accordance with embodiments, there are provided mechanisms and methods for extending a master-detail relationship between objects. These mechanisms and methods for extending a master-detail relationship between objects can enable enhanced data usage, increased efficiency, improved user interaction, etc.

### CLAIM OF PRIORITY

This application claims the benefit of U.S. Provisional Patent Application 61/317,671, entitled “MULTI-LEVEL MASTER DETAIL,” by Baker et al., filed Mar. 25, 2010 (Attorney Docket No. SFC1P096+/274PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to data modeling, and more particularly to developing relationships between data.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Conventional systems (e.g., multi-tenant on-demand database systems, etc.) commonly implement relationships between data stored within the system. For example, a relationship may be defined between two objects stored within the system. Unfortunately, these relationships have been associated with various limitations.

Just by way of example, relationships defined within the system may be limited. For instance, the relationships defined within the system may not extend beyond a particular level within the system. Accordingly, it is desirable to extend relationships between objects within the system.

### BRIEF SUMMARY

In accordance with embodiments, there are provided mechanisms and methods for extending a master-detail relationship between objects. These mechanisms and methods for extending a master-detail relationship between objects can enable enhanced data usage, increased efficiency, improved user interaction, etc.

In an embodiment and by way of example, a method for extending a master-detail relationship between objects is provided. In one embodiment, a first and a second object are identified within a system. Additionally, a master-detail relationship is defined between the first and second objects at a first level. Further, a third object is identified within the system. Further still, the master-detail relationship is extended from the first and second objects to the third object at a second level.

While one or more implementations and techniques are described with reference to an embodiment in which extending a master-detail relationship between objects is implemented in a system having an application server providing a front end for an on-demand database system capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a method for extending a master-detail relationship between objects, in accordance with one embodiment;

FIG. 2 illustrates an exemplary multiple level master-detail relationship, in accordance with another embodiment;

FIG. 3 illustrates a block diagram of an example of an environment wherein an on-demand database system might be used; and

FIG. 4 illustrates a block diagram of an embodiment of elements of FIG. 3 and various possible interconnections between these elements.

### DETAILED DESCRIPTION

### General Overview

Systems and methods are provided for extending a master-detail relationship between objects.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers.

Next, mechanisms and methods for extending a master-detail relationship between objects will be described with reference to example embodiments.

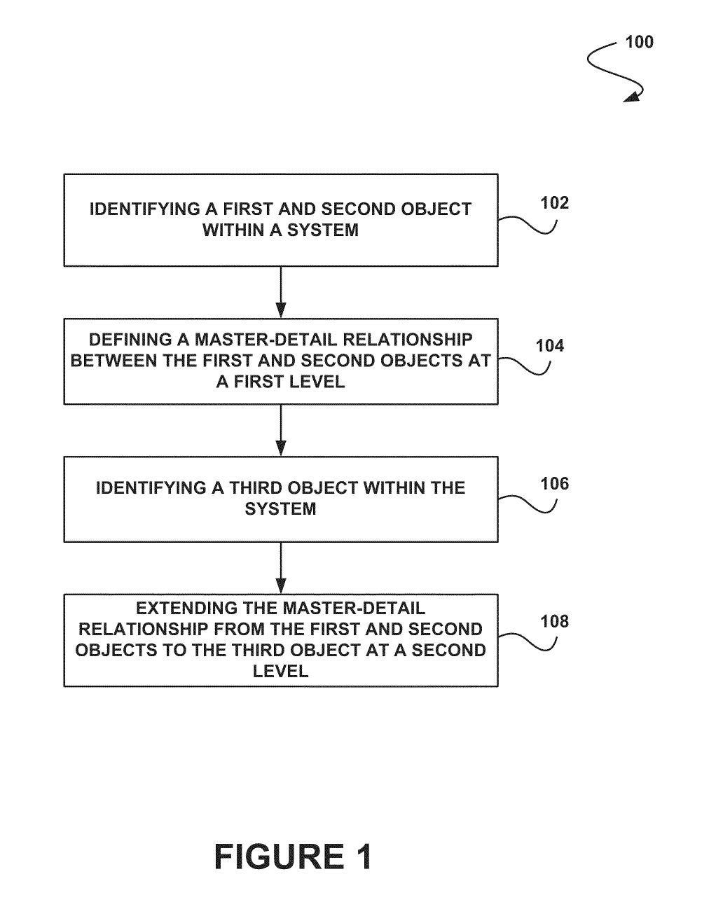

FIG. 1 illustrates a method 100 for extending a master-detail relationship between objects, in accordance with one embodiment. As shown in operation 102, a first and a second object are identified within a system. In one embodiment, an object may include any data stored within the system. For example, an object may include a record of the system (e.g., an order, a receipt, etc.). In another embodiment, an object may include a detail of a record (e.g., a line item, an address, a monetary amount, etc.). In yet another embodiment, an object may include an entity (e.g., a customer, a vendor, a corporation, etc.). In still another embodiment, the object may be a standard object (e.g., an object provided by the system, etc.), a custom object (e.g., an object created by a user of the system, etc.), etc.

Additionally, in one embodiment, the first and second objects may be associated with a tenant of the system (e.g., a client of the system, an organization of the system, etc.). For example, the first and second objects may include objects of an organization of the system. In another embodiment, the system may include a client, a server, a multi-tenant on-demand database system, etc.

Additionally, it should be noted that, as described above, such multi-tenant on-demand database system may include any service that relies on a database system that is accessible over a network, in which various elements of hardware and software of the database system may be shared by one or more customers (e.g. tenants). For instance, a given application server may simultaneously process requests for a great number of customers, and a given database table may store rows for a potentially much greater number of customers. Various examples of such a multi-tenant on-demand database system will be set forth in the context of different embodiments that will be described during reference to subsequent figures.

Furthermore, as shown in operation 104, a master-detail relationship is defined between the first and second objects at a first level. In one embodiment, the master-detail relationship may be defined by a user (e.g., a user associated with an organization, an administrator, etc.). In another embodiment, defining the master-detail relationship may include connecting the first object to the second object such that the second object inherits one or more characteristics from the first object. For example, the second object may inherit one or more of access rules, ownership, sharing, summary fields, etc. from the first object. In yet another embodiment, the first object may include a master object, and the second object may include a detail object.

In this way, the characteristics of the second object may be reliant on the characteristics of the first object. For example, if one or more characteristics of the first object are altered (e.g., an ownership of the first object changes, etc.), such alteration may also be made to the characteristics of the second object. In another embodiment, if the first object is removed from the system, the second object may need to be removed from the system as well. For example, if the first object includes an order of an organization, and the second object includes a line item of the order, then if the order is deleted from within the organization, the line item may be deleted from the organization as well.

Further still, in one embodiment, the master-detail relationship may include a parent-child relationship (e.g., a foreign key relationship, etc.). In another embodiment, the master-detail relationship may include a set of behavior. For example, the master-detail relationship may include a bundled set of behavior that reflects a tightly coupled conceptual relationship between master and detail.

Also, as shown in operation 106, a third object is identified within the system. In one embodiment, the third object may be separate from the first and second objects. In another embodiment, the third object may be associated with the same tenant of the system as the first and second objects.

In addition, as shown in operation 108, the master-detail relationship is extended from the first and second objects to the third object at a second level. In one embodiment, the first object may include a master object, the second object may include a detail object, and the third object may include a subdetail object. For example, the first object may include a community object, the second object may include a discussion topic object, and the third object may include a comment object. In another embodiment, extending the master-detail relationship may include connecting the third object to the second object such that the third object inherits one or more characteristics from the first and second objects. For example, the third object may inherit one or more of access rules, ownership, sharing, summary fields, etc. from the first and second objects.

In another embodiment, within the master-detail relationship, a foreign key to the first object may be a required field to the second object and the third object. In yet another embodiment, deleting the first object may result in a cascade deletion of the second object and the third object. In still another embodiment, sharing access to the second and third objects may be enabled by sharing access to the first object. Also, in one embodiment, the master-detail relationship may be extended from the first and second objects to the third object utilizing recursive code (e.g., in the relationship implementation, etc.).

Further, in one embodiment, the master-detail relationship may be extended from the first, second, and third objects to additional objects at additional levels. For example, additional subdetail objects may be added to the master object. In another embodiment, a limit to the number of additional objects and levels may be imposed. For example, the number of additional objects may be limited at a predefined number. In another example, the number of additional objects and levels may be limited based on a monetary amount paid to the system provider by an organization. In this way, objects within the system may be linked and/or organized in a more detailed fashion. Additionally, users of the system may manage the objects in a more intuitive manner.

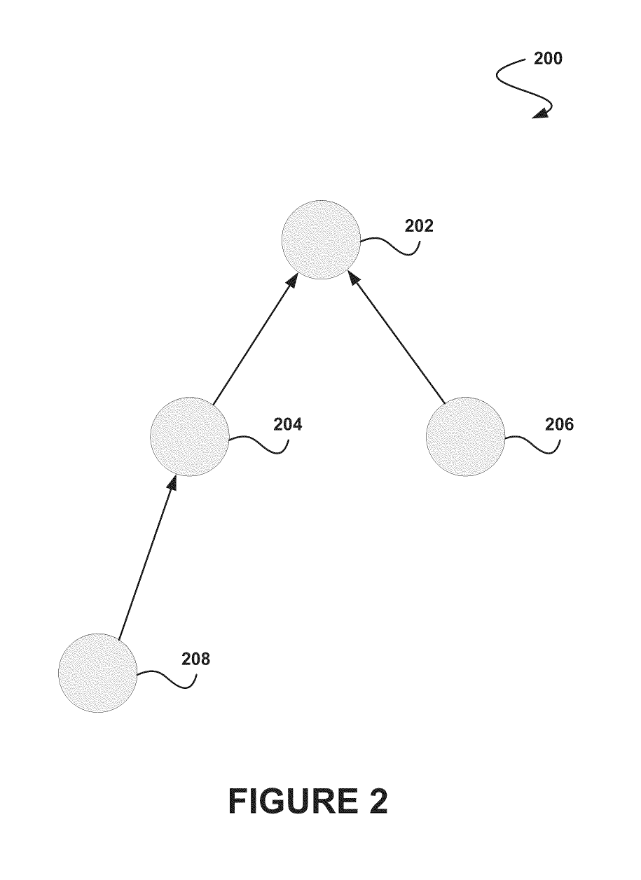

FIG. 2 illustrates an exemplary multiple level master-detail relationship 200, in accordance with another embodiment. As an option, the present relationship 200 may be carried out in the context of the functionality of FIG. 1. Of course, however, the relationship 200 may be carried out in any desired environment. The aforementioned definitions may apply during the present description.

As shown, a master object 202 has a master-detail-relationship with detail objects 204 and 206 as well as subdetail object 208. In one embodiment, the master object 202 may include a customer, detail object 204 may include an order associated with the customer, detail object 206 may include an address associated with the customer, and subdetail object 208 may include a line item associated with the order. In another embodiment, one or more operations may be performed utilizing one or more of the objects within the multiple level master-detail relationship 200. For example, in order to determine the largest order of the customer, an operation may be performed as follows: max(sum(amount)), where the amount is determined at the subdetail object 208, the sum of the amount is determined at the detail object 204, and the max is determined at the master object 202.

Additionally, in one embodiment, standard report types may be enabled for the multiple level master-detail relationship 200. For example, a report type for the relationship 200 may be automatically created, where such report type implements an inner join between the master object 202, the detail object 204, and the subdetail object 208. In another embodiment, roll-up summary fields (RSFs) may be enabled for the multiple level master-detail relationship 200. For example, the master object 202 may include a field that aggregates (e.g., by performing a sum, count, min, max, etc.) fields across records of the detail object 204 and the subdetail object 208. In another example, if a field in subdetail object 208 is updated, the master object 202 and the detail object 204 may be locked and updated utilizing RSFs. In yet another example, the master object 202 may roll-up the fields of the detail object 204, but it may not directly roll-up the fields of the subdetail object 208. To achieve this, the detail object 204 may have a RSF for the sub-detail object 208, and the master object 202 may roll-up from the detail object 204's RSF. In this way, all objects within the multiple level master-detail relationship 200 may be updated when one object is updated.

Further, in one embodiment, custom junction objects (CJOs) may be enabled for the multiple level master-detail relationship 200. For example, detail object 204 may have another master object in addition to master object 202. Additionally, CJOs may not have detail children. In another example, if a CJO is part of a multi-level master-detail relationship they may be the leaf node. In this way, many-to-many relationships may be modeled utilizing the multiple level master-detail relationship 200 in an intuitive manner. In another embodiment, the multiple level master-detail relationship 200 may support cross-object workflow. For example, a field on the master object 202 may be updated from a workflow rule triggered on the detail record 204. Additionally, grandparents may be updated, etc.

Further still, in one embodiment, the master-detail relationship 200 may include a parent-child (e.g., foreign key, etc.) relationship with a bundled set of behavior that reflects a tightly coupled conceptual relationship between master and detail. Table 1 illustrates additional behavior of the multiple level master-detail (MD) relationship 200. Of course, it should be noted that the additional behavior shown in Table 1 is set forth for illustrative purposes only, and thus should not be construed as limiting in any manner.

TABLE 1

| | |
|---|---|
| Field type | A MD relationship may be converted to a lookup relationship. |
| conversion | A lookup relationship may be converted to a MD if the field is not null for all |
| | existing data rows (subject to other rules regarding number of MD relationships |
| | per object, levels, etc.) |
| Page layouts | MD relationship fields may always be shown as required on page layouts, since |
| | they may not be null. |
| Profile | There may be a dependency between the CRUD settings of the detail and the |
| (CRUD) | master. Read permission may be required on master to have any CRUD access |
| security | to the detail. |
| Licensing & | A user may have a license that includes the master object in order to have any |
| provisioning | CRUD access to the detail. For example, this means that a Platform license user |
| | may not see a custom object that is a detail of Opportunity, since the |
| | Opportunity object may not be included with the platform license. |
| Undelete | Undeleting the master may undelete any children which were active when the |
| | master was deleted. In one embodiment, any child who is already soft-deleted |
| | when the master is deleted may be hard-deleted and thus may not be eligible for |
| | undelete. |

Table 2 illustrates exemplary use cases for the multiple level master-detail (MD) relationship 200. Of course, it should be noted that the use cases shown in Table 2 are set forth for illustrative purposes only, and thus should not be construed as limiting in any manner.

TABLE 2

| | |
|---|---|
| Discussions | Community --> Discussion Topic --> Comment |
| Quotes | Account --> Opportunity --> Quote --> Quote Line Item |
| Entitlements | Account --> Contract --> Entitlement |

Also, in one embodiment, the multiple level master-detail (MD) relationship 200 may leverage existing master-detail behavior only with additional detail levels. For example, for the case of the multiple level master-detail (MD) relationship 200, requiredness may be enforced (e.g., the foreign key to the detail object 204 may be a required field on the sub-detail record 208. In another example, deletion rules may be enforced (e.g., deleting a master object 202 may result in cascade deletion of detail object 204 and sub-detail object 208). In yet another example, ownership may be enforced (e.g., security settings for the master object 202 may control the sub-detail object 208). Like the detail object 204, the sub-detail object 208 may not have an owner field and may automatically be owned by the master object 202. Also, like the detail object 204, the sub-detail object 208 may not have sharing rules, manual sharing, queues, etc. With respect to sharing rules of the multiple level master-detail (MD) relationship 200, sharing access to the detail record 204 and the subdetail object 208 may be driven by sharing access to the master object 202.

In addition, in one embodiment, the depth of the multiple level master-detail (MLMD) relationship 200 may be enforced in a custom field wizard, in a change field type wizard, through a metadata application programming interface (API), etc. In another embodiment, additional rules may be enforced through the user interface (UI) and API. For example, no cycles may be allowed within the multiple level master-detail (MD) relationship 200 (e.g., a grandchild of an object may not be a parent of the same object, etc.). In another example, an ancestor of an object may not be a parent of the object.

Further, in another embodiment, optional object types may be supported. For example, the master object 202 in the MLMD relationship 200 may be a standard or custom object. The detail object 204, subdetail object 208, and so on, may be custom objects. For example, a relationship of Account←Custom1←Custom2←Custom3 may be allowed, whereas a relationship of Custom1←Account←Custom2 may not be allowed. In yet another embodiment, the MLMD relationship 200 may hang off a standard object that is a detail object in a master-detail relationship. For example, a relationship of Account←Opportunity←Custom1←Custom2←Custom3 may be allowed.

Further still, in one embodiment, there may be special treatment of the MLMD relationship 200 in a setup user interface (UI). For example, defining the MLMD relationship 200 in the setup may be the same as defining a single level MD. For instance, a custom field wizard may be used to define a master-detail relationship field from a child side of the parent-child relationship. In step 2 of the wizard, the parent (master) may be chosen from a picklist of available objects (which may include all objects that have not already reached any existing depth limit of the MLMD relationship 200).

In another example, the MLMD relationship 200 may be created by converting an existing lookup relationship to MD. For instance, if the parent object already has reached the depth limit of MLMD relationships, a master-detail relationship field radio button may be grayed out with an info icon explaining why.

Table 3 illustrates optional considerations associate with the multiple level master-detail (MD) relationship 200. Of course, it should be noted that the considerations shown in Table 3 are set forth for illustrative purposes only, and thus should not be construed as limiting in any manner.

TABLE 3

| | |
|---|---|
| Field type | Converting relationships from lookup to master-detail and vice-versa may |
| conversion | continue to follow existing rules. |
| Sharing rules | There may be a sharing setting on each level read/write or read-only. The |
| | default read-write may mean that read-write access on the parent may be |
| | required for read-write access on the child. The read-only setting may mean |
| | that only read access may be required on the parent to get read-write on the |
| | child. |
| Profile | There may be a dependency between the CRUD settings of the subdetail, |
| (CRUD) | detail, and the master. Read permission may be required on master to have any |
| security | CRUD access to the detail. Likewise, read permission may be required on the |
| | detail to have any CRUD access to the subdetail. |
| Licensing & | A user may need a license that includes the master object in order to have any |
| provisioning | CRUD access to the detail or subdetail. |
| Undelete | Undelete may work as in existing master-detail relationships. Undeleting the |
| | master may undelete any children, grandchildren, etc. which were active when |
| | the master was deleted. In one embodiment, any child who is already soft- |
| | deleted when the master is deleted may be hard-deleted and thus may not be |
| | eligible for undelete. |
| Import Wizard | Import wizard for custom objects may have the option of doing upsert with |
| | relationships. This may allow an external ID to be used for matching with |
| | existing parent records, rather than requiring the explicit foreign key reference |
| | in the input file. Multiple levels may be supported. |
| Workflow & | Record owner options (approvals, email to owner) may support multiple levels |
| Approval | |
| Processes | |

Additionally, in one embodiment, custom report types may support the multiple level master-detail (MD) relationship 200. For example, the multiple level master-detail (MD) relationship 200 may be used in custom report types. Additionally, there may be a limit as to the number of relationships in the report wizard UI (e.g., a predetermined number limit). In another embodiment, standard report types may be automatically generated for master-detail relationships that appear in the custom report wizard. In yet another embodiment, a platform may not auto-generate CRTs for the MLMD 200 but may put some informational text on the last page of a custom relationship wizard noting that an administrator can create CRTs if they want reports. An option may also be given to jump directly into the CRT wizard with the objects prefilled. In still another embodiment, MLMD reporting support may be based purely on custom report types (CRTs). When an MLMD is created, CRTs may be auto-generated for one or more predetermined combinations within the MLMD.

Also, the auto-generated CRTs may be similar to user-defined CRT's. They may only work for organizations that support CRTs, they may be editable by the usual sets of organizations/users, they may be packageable, etc. Further, if an MLMD relationship is broken, CRTs may be auto-truncated, but auto-deduping may not be performed if there happen to be two CRTs with the same objects. Further still, if a relationship is broken, the CRT may be truncated. If a relationship is changed from master-detail to lookup, it may stay working. Also, if a report on a CRT is truncated, those fields on objects past the broken join may be removed silently from the report. Also, if an MD relationship is not removed, but changed to a lookup, the CRT may still work, all objects and fields may be as before.

Further, in one embodiment, multi-level RSFs may be supported. For example, fields may be directly aggregated across more than one level. In another embodiment, multi-level cross-object workflow may be supported. For example, a grandparent or above may be directly updated via a workflow field update action. In yet another embodiment, multi-level related lists may be supported. For example, a related list of a subdetail object maybe displayed on a master page layout. In still another embodiment, multi-level CJO related lists may be supported. For example, in the parent object in a CJO relationship, fields may be shown from the other parent's parent object. Also, in one embodiment, multi-level workflow and approval/step rules may be supported. For example, a grandparent or above may be referenced in a rule filter. In another embodiment, multi-level relationship traversal in SOQL may be supported. For example, a multi-level relationship may be directly referenced in SOQL.

Further still, in one embodiment, master-detail relationships may be enhanced to include multiple levels. For example, in addition to defining a two-object master-detail relationship, such as account-expense report, the relationship may be extended to subdetail records, such as account-expense report-expense line item. One or more operations may then be performed across the master-detail-subdetail relationship.

In another embodiment, multilevel master-detail relationships may enable the creation of complex data models with linked master-detail relationships. Additionally, the relationships may enable the creation of reports with data from all levels of a complex data model. Further, cascading deletes may be performed when the master record is deleted, removing the need to delete “orphaned” subdetail records. Further still, line-item records that reside in the subdetail objects may be included in roll-up mathematical calculations. Also, custom report types that use data across the multilevel master-detail relationship may be defined. In addition, custom cloud sophisticated data modeling with multilevel master-detail relationships may be supported.

Also, in one embodiment, using this master-detail-subdetail relationship example, the candidate's total rating or overall average may be calculated based on the review object data (e.g., “Candidate (master custom object)-Job Application (detail custom object)-Review (subdetail custom object)”). Additionally, an account with an opportunity to sell a product with accessories at a defined price may be represented as follows: “Master object Account-Detail object Opportunity-Subdetail custom object Product-Subdetail custom object/Accessories-Subdetail custom object Price.”

Additionally, in one embodiment, the rules for multilevel master-detail relationships may be similar to the rules for master-detail relationships, but may extend to linked subdetail records. For example, when a master record is deleted, the related detail and subdetail records may also be deleted. In another example, the owner field on the detail and subdetail records may not be available and may be automatically set to the owner of the master record. In yet another example, custom objects on the “detail” side of a master-detail relationship may not have sharing rules, manual sharing, or queues, as these may require the owner field.

Further, in one example, the security settings for the master record may control the detail and subdetail records. In another example, the master-detail relationship field (which may include the field linking the objects) may be required on the page layout of the detail and subdetail records. In yet another example, the master object may be a standard object, such as an account or opportunity, or may be a custom object.

Further still, in one embodiment, to create multilevel master-detail relationships, “customize application” user permission may be needed. Additionally, when a master-detail relationship is defined, the custom object which is being worked on may be the “detail” side. Its data may appear as a custom related list on page layouts for the other object. Further, if a custom object is a detail or subdetail component of a master-detail relationship, it may not also be the master of a different master-detail relationship. Further still, a predetermined amount of custom detail levels may be allowed (e.g., three custom detail levels, etc).

Also, in one embodiment, standard objects may not be on the detail side of a custom object in a master-detail relationship. Additionally, an object may appear once in multilevel master-detail relationships. For example, a subdetail object in one multilevel master-detail relationship may not also be the owner of the master object in another multilevel master-detail relationship. Further, a subdetail object may not also be the master object of the subdetail object's detail object. Further still, a master-detail relationship may not be created if the custom object already contains data. However, the relationship may be created as a lookup and then may be converted it to master-detail if the lookup field in all records contains a value.

In addition, in one embodiment, converting relationships from lookup to master-detail, or from master-detail to lookup may behave the same as for two-object master-detail relationships. That is, the two linked objects in the detail-subdetail1, or subdetail1-subdetail2 relationship may have the same conversion limits as the master-detail relationship. Further, roll-up summary fields may work as in two-object master-detail relationships. For example, a master may roll up fields on detail records. However, fields may not be directly rolled up on subdetail records. To achieve this, the detail record may have a roll-up summary field for the field on the subdetail record, which may allow the master to roll up from the detail's roll-up summary field.

Further, in one embodiment, multilevel master-detail relationships may be used in custom report types. Additionally, the allow reports checkbox may be checked when the custom object is created. Custom report types created for multilevel master-detail relationships may count towards the organizations custom report type limit and no reports may be generated if this limit is exceeded. Further, “custom junction objects” may not have detail objects. That is, a custom junction object may not become the master object in a multilevel master-detail relationship. Further still, a custom object may not be deleted if it is on the master side of a master-detail relationship.

Also, in one embodiment, custom cloud sophisticated data modeling with multilevel master-detail relationships may be supported. For example, when a custom object that is on the detail side of a master-detail relationship is deleted, the relationship may be converted to a lookup relationship. If the custom object is restored, it may need to be manually converted to a master-detail. Additionally, undeleting the master record may also undelete detail and subdetail records.

In this way, a multiple level master-detail (MLMD) relationship may be provided (e.g., master-detail-subdetail). This type of relationship may be used to model many common business documents and transactions. Additionally, MLMD may be enabled on base platform objects exclusively. This functionality may be hidden behind an org perm available on the blacktab, requiring access level of God. Further, an auto generation of custom report types may be implemented. Further still, MLMD may be added in an organization shape. Also, an NSO (New Save Order) may or may not be disabled unless there are no MLMD relationships.

### System Overview

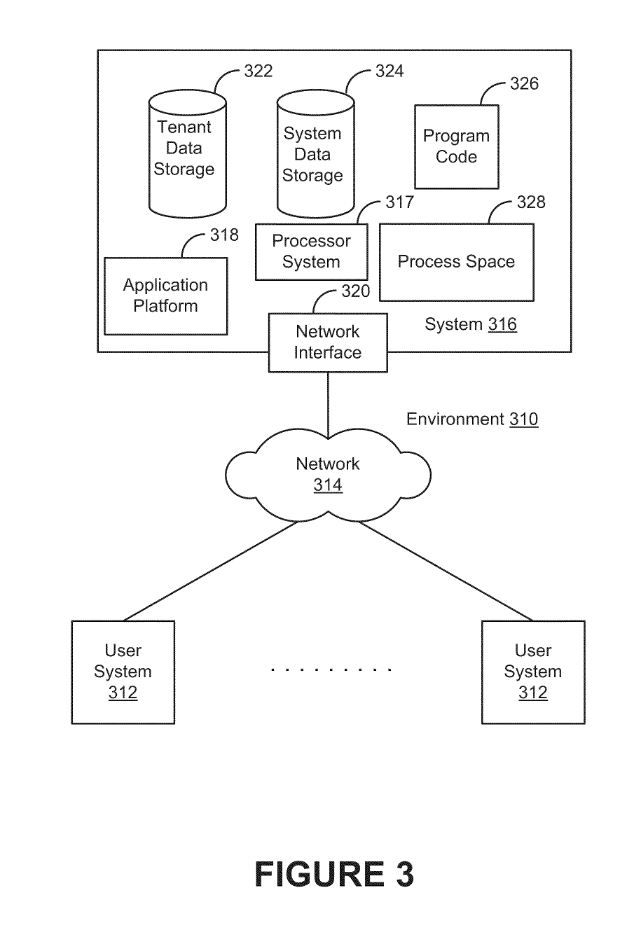

FIG. 3 illustrates a block diagram of an environment 310 wherein an on-demand database system might be used. Environment 310 may include user systems 312, network 314, system 316, processor system 317, application platform 318, network interface 320, tenant data storage 322, system data storage 324, program code 326, and process space 328. In other embodiments, environment 310 may not have all of the components listed and/or may have other elements instead of, or in addition to, those listed above.

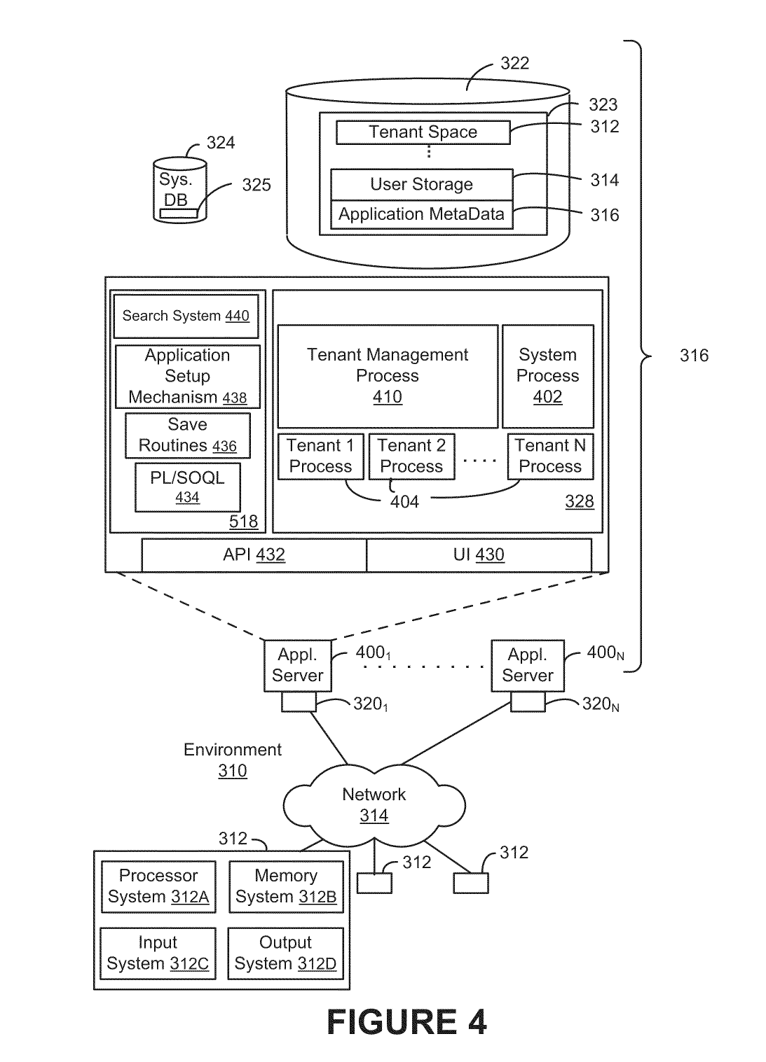

Environment 310 is an environment in which an on-demand database system exists. User system 312 may be any machine or system that is used by a user to access a database user system. For example, any of user systems 312 can be a handheld computing device, a mobile phone, a laptop computer, a work station, and/or a network of computing devices. As illustrated in FIG. 3 (and in more detail in FIG. 4) user systems 312 might interact via a network 314 with an on-demand database system, which is system 316.

An on-demand database system, such as system 316, is a database system that is made available to outside users that do not need to necessarily be concerned with building and/or maintaining the database system, but instead may be available for their use when the users need the database system (e.g., on the demand of the users). Some on-demand database systems may store information from one or more tenants stored into tables of a common database image to form a multi-tenant database system (MTS). Accordingly, “on-demand database system 316” and “system 316” will be used interchangeably herein. A database image may include one or more database objects. A relational database management system (RDMS) or the equivalent may execute storage and retrieval of information against the database object(s). Application platform 318 may be a framework that allows the applications of system 316 to run, such as the hardware and/or software, e.g., the operating system. In an embodiment, on-demand database system 316 may include an application platform 318 that enables creation, managing and executing one or more applications developed by the provider of the on-demand database system, users accessing the on-demand database system via user systems 312, or third party application developers accessing the on-demand database system via user systems 312.

The users of user systems 312 may differ in their respective capacities, and the capacity of a particular user system 312 might be entirely determined by permissions (permission levels) for the current user. For example, where a salesperson is using a particular user system 312 to interact with system 316, that user system has the capacities allotted to that salesperson. However, while an administrator is using that user system to interact with system 316, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 314 is any network or combination of networks of devices that communicate with one another. For example, network 314 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 312 might communicate with system 316 using TCP/IP and, at a higher network level, use other common Internet protocols to communicate, such as HTTP, FTP, AFS, WAP, etc. In an example where HTTP is used, user system 312 might include an HTTP client commonly referred to as a “browser” for sending and receiving HTTP messages to and from an HTTP server at system 316. Such an HTTP server might be implemented as the sole network interface between system 316 and network 314, but other techniques might be used as well or instead. In some implementations, the interface between system 316 and network 314 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 316, shown in FIG. 3, implements a web-based customer relationship management (CRM) system. For example, in one embodiment, system 316 includes application servers configured to implement and execute CRM software applications as well as provide related data, code, forms, webpages and other information to and from user systems 312 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 316 implements applications other than, or in addition to, a CRM application. For example, system 316 may provide tenant access to multiple hosted (standard and custom) applications, including a CRM application. User (or third party developer) applications, which may or may not include CRM, may be supported by the application platform 318, which manages creation, storage of the applications into one or more database objects and executing of the applications in a virtual machine in the process space of the system 316.

One arrangement for elements of system 316 is shown in FIG. 3, including a network interface 320, application platform 318, tenant data storage 322 for tenant data 323, system data storage 324 for system data 325 accessible to system 316 and possibly multiple tenants, program code 326 for implementing various functions of system 316, and a process space 328 for executing MTS system processes and tenant-specific processes, such as running applications as part of an application hosting service. Additional processes that may execute on system 316 include database indexing processes.

Several elements in the system shown in FIG. 3 include conventional, well-known elements that are explained only briefly here. For example, each user system 312 could include a desktop personal computer, workstation, laptop, PDA, cell phone, or any wireless access protocol (WAP) enabled device or any other computing device capable of interfacing directly or indirectly to the Internet or other network connection. User system 312 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 312 to access, process and view information, pages and applications available to it from system 316 over network 314. Each user system 312 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 316 or other systems or servers. For example, the user interface device can be used to access' data and applications hosted by system 316, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 312 and all of its components are operator configurable using applications, such as a browser, including computer code run using a central processing unit such as an Intel Pentium® processor or the like. Similarly, system 316 (and additional instances of an MTS, where more than one is present) and all of their components might be operator configurable using application(s) including computer code to run using a central processing unit such as processor system 317, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 316 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, .HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 316 is configured to provide webpages, forms, applications, data and media content to user (client) systems 312 to support the access by user systems 312 as tenants of system 316. As such, system 316 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 4 also illustrates environment 310. However, in FIG. 4 elements of system 316 and various interconnections in an embodiment are further illustrated. FIG. 4 shows that user system 312 may include processor system 312A, memory system 312B, input system 312C, and output system 312D. FIG. 4 shows network 314 and system 316. FIG. 4 also shows that system 316 may include tenant data storage 322, tenant data 323, system data storage 324, system data 325, User Interface (UI) 430, Application Program Interface (API) 432, PL/SOQL 434, save routines 436, application setup mechanism 438, applications servers 400₁-400_{N}, system process space 402, tenant process spaces 404, tenant management process space 410, tenant storage area 412, user storage 414, and application metadata 416. In other embodiments, environment 310 may not have the same elements as those listed above and/or may have other elements instead of, or in addition to, those listed above.

User system 312, network 314, system 316, tenant data storage 322, and system data storage 324 were discussed above in FIG. 3. Regarding user system 312, processor system 312A may be any combination of one or more processors. Memory system 312B may be any combination of one or more memory devices, short term, and/or long term memory. Input system 312C may be any combination of input devices, such as one or more keyboards, mice, trackballs, scanners, cameras, and/or interfaces to networks. Output system 312D may be any combination of output devices, such as one or more monitors, printers, and/or interfaces to networks. As shown by FIG. 4, system 316 may include a network interface 320 (of FIG. 3) implemented as a set of HTTP application servers 400, an application platform 318, tenant data storage 322, and system data storage 324. Also shown is system process space 402, including individual tenant process spaces 404 and a tenant management process space 410. Each application server 400 may be configured to tenant data storage 322 and the tenant data 323 therein, and system data storage 324 and the system data 325 therein to serve requests of user systems 312. The tenant data 323 might be divided into individual tenant storage areas 412, which can be either a physical arrangement and/or a logical arrangement of data. Within each tenant storage area 412, user storage 414 and application metadata 416 might be similarly allocated for each user. For example, a copy of a user's most recently used (MRU) items might be stored to user storage 414. Similarly, a copy of MRU items for an entire organization that is a tenant might be stored to tenant storage area 412. A UI 430 provides a user interface and an API 432 provides an application programmer interface to system 316 resident processes to users and/or developers at user systems 312. The tenant data and the system data may be stored in various databases, such as one or more Oracle™ databases.

Application platform 318 includes an application setup mechanism 438 that supports application developers' creation and management of applications, which may be saved as metadata into tenant data storage 322 by save routines 436 for execution by subscribers as one or more tenant process spaces 404 managed by tenant management process 410 for example. Invocations to such applications may be coded using PL/SOQL 434 that provides a programming language style interface extension to API 432. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 416 for the subscriber making the invocation and executing the metadata as an application in a virtual machine.

Each application server 400 may be communicably coupled to database systems, e.g., having access to system data 325 and tenant data 323, via a different network connection. For example, one application server 4001 might be coupled via the network 314 (e.g., the Internet), another application server 400N-1 might be coupled via a direct network link, and another application server 400N might be coupled by yet a different network connection. Transfer Control Protocol and Internet Protocol (TCP/IP) are typical protocols for communicating between application servers 400 and the database system. However, it will be apparent to one skilled in the art that other transport protocols may be used to optimize the system depending on the network interconnect used.

In certain embodiments, each application server 400 is configured to handle requests for any user associated with any organization that is a tenant. Because it is desirable to be able to add and remove application servers from the server pool at any time for any reason, there is preferably no server affinity for a user and/or organization to a specific application server 400. In one embodiment, therefore, an interface system implementing a load balancing function (e.g., an F5 Big-IP load balancer) is communicably coupled between the application servers 400 and the user systems 312 to distribute requests to the application servers 400. In one embodiment, the load balancer uses a least connections algorithm to route user requests to the application servers 400. Other examples of load balancing algorithms, such as round robin and observed response time, also can be used. For example, in certain embodiments, three consecutive requests from the same user could hit three different application servers 400, and three requests from different users could hit the same application server 400. In this manner, system 316 is multi-tenant, wherein system 316 handles storage of, and access to, different objects, data and applications across disparate users and organizations.

As an example of storage, one tenant might be a company that employs a sales force where each salesperson uses system 316 to manage their sales process. Thus, a user might maintain contact data, leads data, customer follow-up data, performance data, goals and progress data, etc., all applicable to that user's personal sales process (e.g., in tenant data storage 322). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 316 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 316 might also maintain system level data usable by multiple tenants or other data. Such system level data might include industry reports, news, postings, and the like that are sharable among tenants.

In certain embodiments, user systems 312 (which may be client systems) communicate with application servers 400 to request and update system-level and tenant-level data from system 316 that may require sending one or more queries to tenant data storage 322 and/or system data storage 324. System 316 (e.g., an application server 400 in system 316) automatically generates one or more SQL statements (e.g., one or more SQL queries) that are designed to access the desired information. System data storage 324 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer program product, comprising a non-transitory computer usable medium having a computer readable program code embodied therein, the computer readable program code adapted to be executed to implement a method for extending a master-detail relationship between objects, the method comprising:
identifying a first and a second object within a system;
defining a master-detail relationship between the first and second objects at a first level;
identifying a third object within the system; and
extending the master-detail relationship from the first and second objects to the third object at a second level.

2. The computer program product of claim 1, wherein the object includes a record of the system.

3. The computer program product of claim 1, wherein the first and second objects include objects of an organization of the system.

4. The computer program product of claim 1, wherein the system includes a multi-tenant on-demand database system.

5. The computer program product of claim 1, wherein the master-detail relationship is defined by a user.

6. The computer program product of claim 1, wherein defining the master-detail relationship includes connecting the first object to the second object such that the second object inherits one or more characteristics from the first object.

7. The computer program product of claim 6, wherein the second object inherits one or more of access rules, ownership, sharing, and summary fields from the first object.

8. The computer program product of claim 1, wherein the first object includes a master object, and the second object includes a detail object.

9. The computer program product of claim 1, wherein the third object includes a subdetail object.

10. The computer program product of claim 1, wherein extending the master-detail relationship includes connecting the third object to the second object such that the third object inherits one or more characteristics from the first and second objects,

11. The computer program product of claim 1, wherein the computer program product is operable such that a foreign key to the first object is a required field to the second object and the third object.

12. The computer program product of claim 1, wherein the computer program product is operable such that deleting the first object results in a cascade deletion of the second object and the third object.

13. The computer program product of claim 1, wherein the computer program product is operable such that sharing access to the second and third objects is enabled by sharing access to the first object.

14. The computer program product of claim 1, wherein the master-detail relationship is extended from the first and second objects to the third object utilizing recursive code.

15. The computer program product of claim 1, wherein the computer program product is operable such that the master-detail relationship is extended from the first, second, and third objects to additional objects at additional levels.

16. The computer program product of claim 15, wherein the computer program product is operable such that the number of additional objects and levels is limited based on a monetary amount paid to a system provider by an organization.

17. The computer program product of claim 1, wherein the master-detail relationship includes a parent-child relationship.

18. The computer program product of claim 1, wherein the object is a standard object or a custom object.

19. A method, comprising;
identifying a first and a second object within a system;
defining a master-detail relationship between the first and second objects at a first level, utilizing a processor;
identifying a third object within the system; and
extending the master-detail relationship from the first and second objects to the third object at a second level.

20. An apparatus, comprising:
a processor for:
identifying a first and a second object within a system;
defining a master-detail relationship between the first and second objects at a first level;
identifying a third object within the system; and
extending the master-detail relationship from the first and second objects to the third object at a second level.

21. A method for transmitting code for use multi-tenant database system on a transmission medium, the method comprising:
transmitting code for identifying a first and a second object within a system;
transmitting code for defining a master-detail relationship between the first and second objects at a first level, utilizing a processor;
transmitting code for identifying a third object within the system; and
transmitting code for extending the master-detail relationship from the first and second objects to the third object at a second level.
